(19) United States
(12) Patent Application Publication
(10) Pub. No.: US 2025/0144970 A1
(43) Pub. Date: May 8, 2025

(54) COOLING PLATE AND METHOD OF MANUFACTURING A COOLING PLATE

(71) Applicant: BENTELER AUTOMOBILTECHNIK GMBH, Paderborn (DE)

(72) Inventors: Tobias DUEPMEIER, Paderborn (DE); Elmar GRUSSMANN, Altenbeken-Buke (DE); Jochem GREWE, Salzkotten (DE); Ulrich RUSCHE, Werl (DE); Guenter FORTMEIER, Delbrueck (DE)

(21) Appl. No.: 18/937,029

(22) Filed: Nov. 5, 2024

(30) Foreign Application Priority Data
Nov. 6, 2023 (DE) 102023130623.5

(51) Int. Cl. B60H 1/00; B23P 15/26

(52) U.S. Cl. CPC B60H 1/00278; B23P 15/26

(57) ABSTRACT

A cooling plate for the battery cooling of a motor vehicle has a plate body including two plate elements, joined together by soldering and at least one cooling channel for the passage of a cooling fluid as well as a stiffening molding. The cooling channel and the stiffening molding are initially formed together continuously during the manufacture of the plate body by forming a channel in a plate element, by internal high pressure forming. In the soldering process, a channel portion of the channel sealed fluid-tight by a closing element in the form of a press soldering joint. This separates the channel into a cooling channel and a stiffening molding.

### RELATED APPLICATIONS

The present application claims priority of German Application Number 10 2023 130 623.5 filed Nov. 6, 2023, the disclosure of which is hereby incorporated by reference herein in its entirety.

### FIELD

The present disclosure relates to a cooling plate for battery cooling, for example, e.g., for cooling a battery of motor vehicles, and to a method of manufacturing cooling plates.

### BACKGROUND

High-voltage battery systems are used in electric or hybrid vehicles. A defined thermal management of the batteries is required to ensure range, driving performance and charging performance as well as service life of electrically powered vehicles. The batteries are sensitive to different temperature distributions, which are able to lead to overheating and premature ageing. In order to keep the batteries within an optimum temperature range, cooling devices are used to ensure that excess waste heat generated during battery operation is dissipated from the batteries and that the batteries are kept at an uniform temperature level.

In order to cool batteries or battery modules, cooling plates are used which are arranged above, to the side and/or below the batteries and which contact them directly or indirectly. A cooling fluid flows through the cooling plates. Such cooling plates usually consist of two plates elements which, when assembled to form a plate body, delimit one or more intermediate cooling channels. The cooling plates are able to be made of light metal plates, for example, aluminum sheet metals.

DE 10 2008 059 955 B4 describes a cooling plate and a method for manufacturing a cooling plate with an integrated cooling channel. The cooling plate has a plate body formed from two plate elements, with connections for a cooling fluid. A cooling channel is formed in one plate element of the cooling plate using a chipless forming technique. The plate element provided with the cooling channel is closed by the second flat plate element.

Cooling plates are shown in DE 10 2011 106 662 A1 and DE 10 2011 107 607 A1. Therein the cooling plates or plate bodies are provided with stiffening elements in the form of stiffness moldings or coolant free cavities. This provides additional stiffening of the cooling plates.

### SUMMARY

The object of the present disclosure is to provide a cooling plate which is improved in terms of function and production technology and to indicate a rational method for producing a cooling plate.

A cooling plate has a plate body made up of two plate elements. A cooling fluid is supplied and discharged via connecting pieces. The connection pieces are joined to the plate body or its plate elements with a material bond. The plate elements are, for example, a channel plate and a base plate, which are joined together to form a plate stack and form the plate body. The plate elements are made of light metal or a light metal alloy, for example, an aluminum alloy. At least one plate element of the plate body of the cooling plate has a channel structure for the passage of a cooling fluid. The plate elements are materially joined by means of press soldering. The soldering process is carried out in a form soldering tool. For this purpose, a plate stack formed from the two plate elements is clamped in the form soldering tool, pressed together and heated to a temperature above the melting temperature of the soldering material applied between the plate elements, so that the soldering material changes into a liquid phase by melting and, after the soldering material has solidified, a material bond is formed between the plate elements at the adjacent joining surfaces.

To form one or more channels in at least one of the plate elements, the plate elements are clamped in the form soldering tool and an intermediate space between the plate elements is subjected to internal pressure. For this purpose, an active medium is fed into the intermediate space and a channel structure with at least one or more channels is created using internal high pressure technology.

A cooling plate for battery cooling according to the present disclosure has a plate body which is formed from two plate elements joined together by soldering. The plate body has a channel structure with at least one cooling channel for the passage of a cooling fluid and at least one stiffening molding. The stiffening molding serves to stiffen the plate body and improves the dimensional stability of the cooling plate. A high degree of dimensional stability ensures good contact between the cooling plate and the battery modules. This is advantageous for thermal management. High dimensional stability of the cooling plates also has a positive effect in the event of a crash load, as well as during handling in the assembly process of the battery arrangement and the cooling system.

According to the present disclosure, a channel portion between the cooling channel and the stiffening molding is sealed fluid-tight by a closing element.

The stiffening molding is formed by a groove- or bead-shaped molding in at least one plate element. The stiffening molding is produced together with the cooling channel during the internal high-pressure forming viz. internal high pressure process. The closing element separates the channel formed between the plate elements into a cooling channel and a stiffening molding. In this way, an improved cooling plate is created in terms of function and production technology. The production of the cooling plates and the stiffening structures with the stiffening moldings in the cooling plate is efficient, cost-effective and saves installation space. The arrangement and geometry of the stiffening moldings, e.g., of multiple stiffening moldings that form a stiffening structure, ensure a high degree of dimensional stability of the cooling plate with component-specific high rigidity with respect to the weight of the battery or the battery modules as well as the loads and forces that occur during driving.

Coolant does not flow through the stiffening moldings. The coolant flow is separated in a fluid-tight manner by the closing element. At least one or more openings are provided in a stiffening molding. These are functional openings through which the stiffening moldings are ventilated or which are used for fastening, for example to connect the cooling plate to a base plate.

A method of manufacturing a cooling plate has the following steps:
providing a plate stack, which is formed from at least two plate elements made of a metallic material with a soldering material arranged between the plate elements;
inserting the plate stack into a heated form soldering tool, which has a lower tool and an upper tool;
closing the forming tool, wherein the lower tool and the upper tool are moved towards each other;
closing the form soldering tool and clamping the plate stack between the lower tool and the upper tool;
heating up the plate stack;
applying internal pressure to an intermediate space between the plate elements of the plate stack by introducing an active medium into the intermediate space and forming a channel in at least one plate element;
melting the soldering material between the plate elements and soldering of the plate elements to the contacting joint surfaces;
wherein a closing element is created by which the channel is separated into a cooling channel and a stiffening molding;
opening the form soldering tool and removing the cooling plate from the form soldering tool.

The closing element is produced by a press soldering joint in the soldering process. Here, the closing element is formed in a channel portion of the channel created using internal high pressure technology. Several stiffening moldings are able to be created. Accordingly, multiple channel portions are each closed by a closing element, whereby a stiffening molding is separated from the cooling channel or channels.

Prior to the fluid-tight separation of the cooling channel and the stiffening molding, these are connected via the channel portion. The channel portion is part of the hydroformed channel. The channel portion is able to be geometrically smaller than a cooling channel and/or a stiffening molding. In at least one embodiment of the present disclosure, the channel portion is able to have a smaller cross-section than a cooling channel or a stiffening molding. The channel portion is sealed fluid-tight by the closing element.

In at least one embodiment of the present disclosure, an opening is created in a stiffening molding, so that stiffening molding ventilated. The opening is able to be created in the soldering tool. In at least one embodiment of the present disclosure, one or more openings are produced in a stiffening molding outside the form soldering tool after the cold plate has been produced.

The form soldering tool is heated to the tool temperature at which both the internal high pressure process and the soldering joining process are carried out. In at least one embodiment of the present disclosure, the tool temperature is between 540° C. and 670° C., or the tool temperature is between 550° C. and 640° C.

In at least one embodiment of the present disclosure, multiple stiffening moldings, for example, stiffening beads, to extend parallel to a cooling channel, a cooling channel portion, a cooling channel structure or multiple cooling channels.

When creating the soldered connection between the plate elements, the channel portion is closed during the soldering process by a punch in the form soldering tool pressing the channel portion closed so that it is also soldered. This creates a stiffening molding separate from the cooling channel with a hollow chamber through which cooling fluid does not flow during operation but which increases the component rigidity.

In at least one embodiment of the present disclosure, the closing process of the form soldering tool is interrupted before the closing position is reached. The upper tool and the lower tool are positioned at a distance from each other in this holding position when the plate stack is inserted. The holding position is held for a holding time. This heats up the stack of plates resting on the lower tool. After the holding time, the closing movement is continued, the form soldering tool is closed and the stack of plates is clamped between the lower tool and the upper tool. Clamped in the form soldering tool, the plate stack is heated further to soldering temperature.

### BRIEF DESCRIPTION OF THE DRAWING(S)

Further advantages, features, properties and aspects of the present disclosure are the subject of the following description. Various embodiments are shown in schematic figure(s). These serve to facilitate understanding of the present disclosure. In the drawing(s):

FIG. 1 shows a perspective view of a cooling plate according to at least one embodiment of the present disclosure.

### DETAILED DESCRIPTION

A cooling plate 1 is used to cool the battery, for example, a vehicle battery of a motor vehicle.

The cooling plate 1 has a plate body 2, which is formed from two plate elements 3, 4. The plate element 3 at the front in the plane of the FIGURE is a channel plate that has a channel structure with at least one cooling channel 5. The rear plate element 4 indicated in the FIGURE is a base plate that is usually completely or almost completely flat.

The two plate elements 3, 4 are positioned flat on top of each other and form the plate body 2. The adjacent surfaces of the plate elements 3, 4 are provided with a soldering material in whole or in part. In at least one embodiment of the present disclosure, a soldering material in the form of a plated solder layer is pre-applied to one of the plate elements 3, 4.

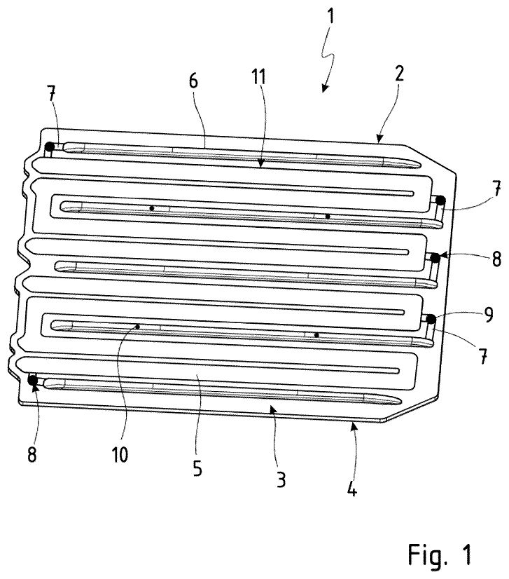

The adjacent surfaces of the plate elements 3, 4 are joined together in whole or in part. Connecting pieces for a cooling fluid, not shown in FIG. 1, are connected to the plate body 2. The connection pieces are used to supply and discharge a cooling fluid.

The plate body 2 has a stiffening structure with one, or multiple, stiffening moldings 6. A stiffening molding 6 is designed in the form of a stiffening bead. A stiffening molding 6 and a cooling channel 5 were originally connected via a channel portion 7. The channel portion 7 between the cooling channel 5 and the stiffening shaping 6 is sealed fluid-tight by a closing element 8. The closing element 8 is formed by a press soldering joint 9.

One or more openings 10 are provided in a stiffening molding 6. The openings 10 are used to ventilate the stiffening molding 6 or to attach thereto with functional components and are created following the manufacture of the cooling plate 1 or the plate body 2.

The cooling channel 5, the stiffening moldings 6, the channel portions 7 and the closing elements 8 that close a channel portion 7 in a fluid-tight manner are produced during the manufacture of a cooling plate 1 or the plate body 2.

To produce a cooling plate 1, a plate stack includes at least two initially flat plate elements 3, 4 made of an aluminum alloy is provided. A soldering material is applied between the plate elements 3, 4, wherein the soldering material is applied to at least one of the plate elements 3, 4 in the form of a plated solder layer.

The plate stack is placed in a heated form soldering tool.

The form soldering tool has a lower tool and an upper tool. These are displaced relative to each other during the closing movement of the form soldering tool. In at least one embodiment of the present disclosure, the upper tool is lowered onto the lower tool. The closing movement is interrupted to heat up the plate stack. The upper tool and the lower tool are located at a small distance from each other. The distance is a few centimeters. The plate stack rests loosely on the lower tool and is preheated. After this heating phase, which is able to last longer than 5 seconds and less than 1 minute, or between 10 and 30 seconds, the form soldering tool is completely closed by lowering the upper tool onto the lower tool. The plate stack is received and clamped between the lower tool and the upper tool. The plate stack comes into surface contact between the lower tool and the upper tool and is heated further in the form soldering tool. The form soldering tool is heated to a tool temperature at which both the forming process and the soldering joining process are carried out. In at least one embodiment of the present disclosure, the tool temperature is between 540° C. and 670° C., or the tool temperature is between 550° C. and 640° C.

An intermediate space between the plate elements 3, 4 of the plate stack is subjected to internal pressure. An intermediate space is an area between adjacent plate elements, wherein there does not necessarily have to be a gap between plate elements in the area of the intermediate space. Internal pressure is applied to the intermediate space by introducing an active medium, for example, nitrogen, into the intermediate space. Here, a channel 11 is formed by forming at least one plate element area into a channel cavity in one or the contact surfaces of the form soldering tool using internal pressure. The active medium is supplied via one of the connection pieces of the plate stack or an external connection adapter.

The soldering material between the plate elements 3, 4 is melted as a result of the tool temperature of the form soldering tool. The plate elements 3, 4 and the connection pieces, which are positioned correctly for joining, are soldered together.

During the production of the press soldering joint of the plate elements 3, 4, channel portions 7 of the channel 11 are closed by a closing element 8 in the form of a press soldering joint 9. This separates the channel 11, which is created using internal high pressure technology, into the cooling channel 5 and the stiffening moldings 6. The cooling channel 5 and the stiffening moldings 6 were connected via the channel portion 7 during the internal high pressure process. These connections or the channel portions 2 are closed during the soldering process by closing elements 8. For this purpose, press soldering joints 9 are created in the channel portions 7 by a punch in the form soldering tool pressing the channel portion 7 closed so that the channel portion 7 is soldered. In this way, the cooling channel(s) 5 is/are created, which are intended and set up for the passage of a cooling fluid. Furthermore, multiple stiffening moldings 6 are created, through which cooling fluid does not flow during operation. The stiffening moldings 6 increase the dimensional stability and component rigidity.

The form soldering tool is opened after completion of the form soldering process, wherein the lower tool and the upper tool are displaced relative to each other and moved apart. The joined hot plate body 2 or the cooling plate 1 is able to be removed from the form soldering tool after having been opened. Before removal, the cooling plate 1 is able to be held in the form soldering tool and cooled down. Cooling is carried out to below the melting temperature of the soldering material.

The plate stack is clamped between the lower tool and the upper tool during the production of the cooling plates. During the internal pressure molding and forming of the channel 11 and the fluid-tight separation of the channel 11 into a cooling channel 5 and stiffening moldings 6, for example, a stiffening bead, the plate stack is sealed circumferentially along adjacent edge regions and/or adjacent to the channel cavity. The sealing is able to be effected or supported by pressure elements provided in the lower tool and/or in the upper tool. Such pressure elements are optional and are also able to be provided in the area of connecting pieces. The pressure elements are able to be formed by a corresponding contour in the mold portions of the lower tool and/or the upper tool, for example, by sealing beads. The closing elements are able to be provided circumferentially along adjacent edge regions of the upper tool and/or lower tool. The closing elements are also able to be provided adjacent to the channel cavity. The closing elements ensure the forming process takes place in the region of the channel cavity. This ensures high dimensional stability and forming accuracy.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-11. (canceled)

12. A cooling plate for battery cooling, comprising:
a plate body, which has two plate elements joined together by soldering;
at least one cooling channel for the passage of a cooling fluid; and
a stiffening molding, wherein a channel portion between the at least one cooling channel and the stiffening molding is closed in a fluid-tight manner by a closing element.

13. The cooling plate according to claim 12, wherein the closing element comprises a joint or a press soldering joint.

14. The cooling plate according to claim 12, wherein the stiffening molding comprises a channel-shaped or bead-shaped molding in at least one of the two plate elements.

15. The cooling plate according to claim 12, wherein the stiffening molding has an opening.

16. The cooling plate according to claim 12, wherein the at least one cooling channel and the stiffening molding are formed internally at high pressure.

17. A method of manufacturing a cooling plate, the method comprising:
forming a plate stack from
at least two plate elements comprising a metallic material, and
a soldering material arranged between the at least two plate elements;
inserting the plate stack into a heated form soldering tool, which has a lower tool and an upper tool;
closing the heated form soldering tool, wherein the lower tool and the upper tool move towards each other to clamp the plate stack between the lower tool and the upper tool;
heating up the plate stack;
an internal pressure process of applying internal pressure to an intermediate space between the at least two plate elements by introducing an active medium into the intermediate space and forming a channel in at least one plate element of the at least two plate elements;
a soldering joining process of melting the soldering material between the at least two plate elements and soldering joining of the at least two plate elements to contacting joint surfaces to obtain the cooling plate, wherein a closing element is formed by which the channel is separated into a cooling channel and a stiffening molding; and
opening the heated form soldering tool and removing the cooling plate from the heated form soldering tool.

18. The method according to claim 17, wherein the closing element is produced by a press soldering joint in the soldering joining process.

19. The method according to claim 17, wherein the closing element is in a channel portion of the channel.

20. The method according to claim 17, wherein an opening is produced in the stiffening molding.

21. The method according to claim 17, wherein the heated form soldering tool is heated to a tool temperature of between 540° C. and 670° C. during the internal pressure process and the soldering joining process.

22. The method according to claim 17, wherein
the closing of the heated form soldering tool is interrupted for a holding time before reaching a closing position, wherein the upper tool and the lower tool are positioned at a distance from each other with the plate stack inserted therebetween, and
after the holding time, the heated form soldering tool is closed and the plate stack is clamped between the lower tool and the upper tool.

23. The method according to claim 17, wherein the heated form soldering tool is heated to a tool temperature of between 550° C. and 640° C. during the internal pressure process and the soldering joining process.
